(19) United States
(12) Patent Application Publication
(10) Pub. No.: US 2011/0051699 A1
(43) Pub. Date: Mar. 3, 2011

(54) Traffic Forwarding in Mesh Networks

(76) Inventor: Gopalakrishnan Raman, Santa Clara, CA (US)

(21) Appl. No.: 12/547,042

(22) Filed: Aug. 25, 2009

(51) Int. Cl. H04W 40/00

(52) U.S. Cl. 370/338; 370/445

(57) ABSTRACT

Prioritizing traffic forwarding in a wireless mesh network. In a wireless mesh network using carrier detect multiple access-collision avoidance with backoff, such as mesh networks supporting IEEE 802.11 clients, access points in the mesh are assigned levels according to their distance in hops from the root node of the mesh. Access points in the mesh then generate backoff times proportional to their level in the mesh. This has the effect of prioritizing traffic at those levels close to the mesh root.

### BACKGROUND OF THE INVENTION

The present invention relates to wireless digital networks, and in particular, to the problem of traffic forwarding in mesh networks.

Wireless digital networks commonly have a controller to which are attached one or more access points. Each access point supports a number of wireless clients. In most situations, each access point connects to its controller using a wired connection. Such wired connections, for example using 803.2 Ethernet and often 802.3af power over Ethernet, provide a high capacity channel between controller and access points.

In some situations, however, it is not possible to provide wired data connections to access points. Examples include large outdoor installations, such as rail yards, cargo terminals, and large college campuses. In such situations mesh networks are used. In a mesh network, only a few, perhaps only one access point has a wired connection to a controller. This access point may be referred to as a portal, or a root node. All other access points in the mesh network communicate wirelessly, access point to access point. Access points are organized into a mesh, a network usually represented topologically as a tree with its origin, or root, the access point with the wired connection to the controller.

In the operation of a mesh network, traffic from a client connected to an access point passes through the mesh in a directed fashion from access point to access point until the traffic finally reaches the root node. Similarly, traffic flows through the root node, and through a succession of access points until it reaches the access point to which the client is attached.

For various engineering reasons, mesh networks typically operate using a single radio channel for transferring data within the mesh, that is, from access point to access point. In many installations, this same channel may also be used in communicating between the access point and the wireless client.

A problem arises due to the tree structure of the mesh. As traffic flows from multiple wireless clients up to the portal or root node, more and more traffic must be aggregated through fewer mesh nodes. While access points at each level of the mesh buffer traffic in a store-and forward fashion, and may apply rules to prioritizing traffic, access points serving as mesh nodes are called upon to carry more and more traffic as the root or portal node is approached; in peak traffic conditions, the capacity of that access point and the channel will be exceeded, and packets comprising the traffic must be dropped.

What is needed is a way of prioritizing traffic within access points in the mesh.

### BRIEF DESCRIPTION OF THE DRAWINGS

The invention may be best understood by referring to the following description and accompanying drawings that are used to illustrate embodiments of the invention in which:

FIG. 1 shows a mesh network.

### DETAILED DESCRIPTION

Embodiments of the invention relate to methods of prioritizing traffic flow in a wireless mesh network. In an embodiment of the invention for wireless networks practicing carrier sense multiple access collision avoidance (CSMA/CA) with backoff, such as IEEE 802.11 wireless networks, access points in a mesh network are represented in a tree topology with the root or portal node as level 0 of the tree, and each successive level of access points having a level of one plus the level of the access point to which they connect. Wireless traffic is prioritized by having access points use a backoff time proportional to their level or distance to the root or portal node.

CSMA/CA with exponential backoff is specified as part of the IEEE 802.11 standard, IEEE-Std 802.11-1999 (R2003) incorporated herein by reference, and is practiced by devices operating in accordance with the standard.

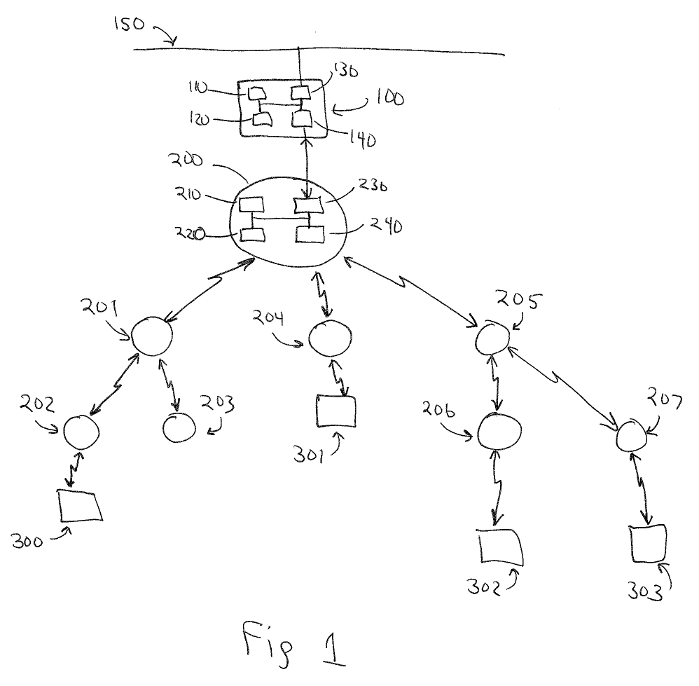

FIG. 1 shows a mesh network in which controller 100 connected to wired network 150 supports a plurality of access points forming a mesh network. A wired connection is provided between controller 100 and access point 200, the root node of the mesh. Access points 201, 202, 203, 204, 205, 206, 207 operate as mesh nodes and connect wirelessly as shown to root 200. Client devices 300, 301, 302, 303 connect wirelessly through the mesh.

As shown in FIG. 1, client 300 connects wirelessly to access point 202 which in turn connects wirelessly to access point 201 which in turn connects wirelessly to access point 200, the root of the mesh.

Controller 100 is a purpose-built digital device having a CPU 110, memory hierarchy 120, and a plurality of network interfaces 130. CPU 110 may be a MIPS-class processor from companies such as Raza Microelectronics or Cavium Networks, although CPUs from companies such as Intel, AMD, IBM, Freescale, or the like may also be used. Memory hierarchy 120 includes read-only memory for device startup and initialization, high-speed read-write memory such as DRAM for containing programs and data during operation, and bulk memory such as hard disk or compact flash for permanent file storage of programs and data. Wired network interfaces 130 and 140 are typically IEEE 802.3 Ethernet interfaces to copper, although high-speed optical fiber interfaces may also be used. Controller 100 typically operates under the control of purpose-built embedded software, typically running under a Linux operating system, or an operating system for embedded devices such as VXWorks. Controller 100 may have dedicated hardware for encryption, and/or for routing packets between network interfaces. Memory hierarchy 120 may also contain a Trusted Platform Module (TPM), an industry-standard device for providing secure storage.

Access points 200-207 are also a purpose-built digital devices having a CPU 210, memory hierarchy 220, a first wired interface 230, and wireless interface 240. As with controller 100, the CPU commonly used for such access nodes is a MIPS-class CPU such as one from Raza Microelectronics or Cavium Networks, although processors from other vendors such as Intel, AMD, Freescale, and IBM may be used. Memory hierarchy 220 comprises read-only storage such as ROM or EEPROM for device startup and initialization, fast read-write storage such as DRAM for holding operating programs and data, and permanent bulk file storage such as compact flash memory. Memory hierarchy 220 may also contain a TPM. Remote access points 200-207 typically operate under control of purpose-built programs running on an embedded operating system such as Linux or VXWorks. Wireless interface 240 is typically an interface operating to the family of IEEE 802.11 standards including but not limited to 802.11a, b, g, and/or n.

Many wireless digital networks, such as IEEE 802.11 wireless networks practice carrier sense multiple access with collision avoidance (CSMA/CA) as a method of sharing a common channel among multiple devices. In CSMA/CA schemes, a device listens on the channel prior to transmitting, waiting for the channel to be idle. If the channel is busy, the device waits, or backs off, a predetermined period of time before checking again. When the channel is sensed as idle, the device also waits, or backs off, a predetermined period of time before transmitting. As described in section 9.1.1 of the IEEE 802.11 standard, this backoff time is random, and increases exponentially with subsequent attempts. This backoff process seeks to avoid collisions.

According to the present invention, access points in a mesh network calculate a figure representing their level, or distance in hops to the root or portal node, and use backoff times proportional to that figure. In operation, nodes closest to the root or portal node will on average wait shorter periods of time before transmitting than nodes farther away from the root or portal node. These shortened periods are shorter than those practiced by devices practicing the 802.11 standard. This has the effect of placing a higher priority on traffic being transmitted by nodes closest to the portal or root node.

This level may be calculated in a number of ways known to the art. In one embodiment, access points forming the mesh are enumerated by walking the tree formed by the mesh. This process may be incorporated into the process of organizing nodes into the mesh, or reorganizing nodes in the mesh when the mesh topology changes. Walking or coloring the tree, as is known to the art, assigns levels to the access points, with the root or portal being level 0, the access points connecting to the root are level 1, and so on. Depth first searches and breadth first searches are approaches to walking the tree and assigning levels. As an example the numbering of access points 201 through 207 in FIG. 1 are the result of a depth-first search.

As shown in FIG. 1, access points 201, 204, and 205 are at level 1 of the mesh. Access points 202, 203, 206, and 207 are at level 2 of the mesh. Access points 201, 204, and 205 are one hop away from root node 200. Access points 202, 203, 206, and 207 are two hops away from root node 200.

In another embodiment, nodes in the mesh use a dedicated field in a protocol header to count how many hops a packet takes through the mesh. The header could be the mesh header as described in IEEE-80211s/D2.0 Part 11 or it could be a higher level protocol header such as TCP/IP. The header field is incremented each time a node forwards a packet. In such an embodiment, a node may determine its level in the mesh by examining this field in packets coming from root node 200.

Once access points in the mesh have an identified level, this level is used as the distance to the root, and is used in generating backoff times in transmitting on the channel.

Examining FIG. 1, all traffic to and from client devices 302 and 303 must pass through access point 205. When client 302 wishes to send a packet to a service on network 150, it transmits that packet to access point 206 on the mesh. Access point 206 then transmits the packet to access point 205 on the mesh, which sends it to access point 200.

If client devices 302 and 303 are generating substantial amounts of traffic, such as occurs in sensor networks, surveillance applications, and industrial control applications, access point 205 is going to be very busy. While it is common for access points to incorporate queues for holding data to be transmitted, particularly in a mesh environment, it is easy for those queues to be filled.

According to the 802.11 standard, when the shared radio channel used by mesh nodes 200-207 goes idle, stations wishing to transmit wait a randomized period of time with exponential backoff according to the algorithm specified in the standard. At the end of that interval, if the channel is still idle, the station begins transmitting. This insures fairness.

According to the present invention, access points in the mesh calculate their wait and backoff times using their level from the mesh, and do so in a manner which results in shorter times than those specified in the standard.

According to the present invention, if both access points 205 and 206 have traffic to transmit, when the shared channel goes idle, access point 205 at level 1 of the mesh will generate a wait time that is less than the wait time generated by access point 206 which is at level 2 of the mesh. Similarly, access point 206 will generate a wait time which is less than the wait time generated by client device 302. This has the effect, then, of prioritizing traffic transmitted by access points closer to the root of the mesh. This prioritization has the effect of moving traffic from the edges of the mesh, i.e from the client devices to the wired network also referred to as upstream direction.

The present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A method of operating a node in a wireless mesh network having a root node and a plurality of mesh nodes comprising:
assigning a level to the node related to the node's distance in hops to the root node, and
generating backoff times used in transmitting packets on the mesh network wherein the backoff times are proportional to the level of the node.

2. The method of claim 1 where the mesh network supports clients using the IEEE 802.11 standard.

3. The method of claim 1 where backoff times proportional to the level of the node are applied to traffic flowing to the root node.

4. The method of claim 1 where at least some of the backoff times generated are shorter than the backoff times specified in the IEEE 802.11 standard

5. Software for operating a node in a wireless mesh network having a root node and a plurality of mesh nodes comprising:
a level generator for assigning a level to the node wherein the level is related to the node's distance in hops from the root node, and
a backoff generator for generating backoff times used in transmitting packets on the mesh network, wherein the generated backoff times are proportional to the level, wherein the level generator and the backoff generator are software digitally encoded in a computer readable medium executable by a computing device, which causes the computing device to perform a set of actions for which the level generator and the backoff generator are configured.
